(19) United States
(12) Patent Application Publication
(10) Pub. No.: US 2004/0066064 A1
(43) Pub. Date: Apr. 8, 2004

(54) Standing structure and releasing holder

(76) Inventors: Andrew S. Neely, Knoxville, TN (US); John W. Endsley, Knoxville, TN (US)

Correspondence Address: LUEDEKA, NEELY & GRAHAM, P.C., P O BOX 1871, KNOXVILLE, TN, 37901, US

(21) Appl. No.: 10/676,618

(22) Filed: Oct. 1, 2003

Related U.S. Application Data
(60) Provisional application No. 60/415,404, filed on Oct. 2, 2002.

(51) Int. Cl. B60N 2/32; A47C 13/00; A45D 19/04; A47J 47/16

(52) U.S. Cl. 297/118; 248/155.4

(57) ABSTRACT

A standing structure is formed by a plurality of poles and a holder movable between an open position and a closed position. In the closed position, the holder is dimensioned and configured to grip each of the plurality of poles and hold the poles in a standing structure. The poles form the legs of the structure. The holder is also configured to release the poles when moved to the open position to enable disassembly of the standing structure. A closure mechanism secures the holder in a closed position and a release mechanism releases the closure mechanism and thereby releases the poles from the holder. Accessories may be mounted on the standing structure. For example, with the holder attached to the midsection of the poles, a seat is mounted on the upper ends of the poles to form a stool. With the holder attached to the upper ends of the poles, accessories such as a camera mount, a table top, or a lantern may be attached to the holder to form various useful structures.

### CROSS REFERENCE TO RELATED APPLICATION

The present application claims the benefit and priority based upon provisional application serial No. 60/415,404 entitled STANDING STRUCTURE AND RELEASING HOLDER filed by Andrew S. Neely and John w. Endsley on Oct. 2, 2002.

### FIELD OF INVENTION

The present invention relates to the field of standing structures, and particularly relates to portable collapsible standing structures such as stools constructed from poles with releasing holders.

### BACKGROUND OF INVENTION

Serious outdoorsmen and sportsmen consider walking poles essential equipment for many outings. For example, serious backpackers on long-distance hikes often use trekking poles even though they are also making every effort to reduce the weight that they carry. A serious through-hiker on the Appalachian trail may carry only a single small aluminum pot as the only piece of cooking equipment, and yet they carry trekking poles.

Fly fisherman also carry walking poles, typically a wading staff. Again, even though extreme measures are taken to avoid weight, many fly fishermen choose to use a wading staff for both convenience and safety. A wading staff is extremely useful when wading swift water, but is only marginally useful when out of the water.

### SUMMARY OF INVENTION

Given the essential nature of walking poles, and given the marginal utility of such poles beyond their primary purpose, additional uses for such poles would be a great benefit. After a long day of backpacking and pitching a camp, an elevated seat near the camp fire is man's best friend. Ideally all campfires would come equipped with a large log about 18 to 30 inches in diameter positioned immediately next to the fire, but not too close. Unfortunately not all campfires are so equipped, and after a long day of hiking most campers dine with their butts on the ground with only their scotch to comfort them in the cold wet darkness.

Likewise, fly fishermen sit in brooding thought on the damp riverbank waiting for the next hatch. Both of these outdoorsmen could benefit from an ability to convert their walking poles into seats. The invention gives these outdoorsmen a seat.

In accordance with one embodiment of the present invention a standing structure is constructed from walking poles, and one of those standing structures is a tripod stool. The pole and structure apparatus of the present invention includes a plurality of poles with each pole having a midsection and upper and lower ends. One source of these poles would be a disassembled walking pole, such as a wading staff or trekking pole. A holder is provided for holding the poles in a standing structure. The holder has open and closed positions, and it is dimensioned and configured to grip of the plurality of poles when the holder is in a closed position. By gripping the poles, the holder creates a standing structure having a plurality of legs held in position for engaging the ground to create the standing structure (such as a stool base). The holder is also configured to release the poles when it is moved to the open position to enable disassembly of the structure. A closure mechanism is associated with the holder and secures the holder in the closed position to secure the poles in their desired position. In addition, a release mechanism is associated with the holder and the closure mechanism for releasing the closure mechanism and thereby releasing the poles from the holder to enable disassembly of the standing structure.

In one embodiment the holder is a hub which includes a plurality of movable hub components. These components move between closed positions and open positions. Cylindrical receivers are formed by the hub components when in the closed position, and the receivers are dimensioned to receive and tightly grip the poles when the closure mechanism holds the hub components in a closed position. The hub components when moved to the open position are configured and dimensioned to release the poles.

In one embodiment the hub engages the midsection of the three poles to form a tripod structure suitable for creating a tripod seat. In this embodiment a triangular seat is placed on the upper ends of the poles. The triangular seat has pockets formed in its three corners, and the upper ends of the poles are received in the pockets. The dimensions of the seat are chosen to tightly suspend the seat between the poles so that the fabric seat will support the weight of a sportsman, which is often substantial. In a preferred embodiment, one closure mechanism is an over-the-center clamp that applies a force to the holder urging it toward a closed position. In other embodiments, the closure mechanism is a ratchet axle that allows the components to move together but not apart, until the ratchet axle is released, in which case the components move apart.

The holder may comprise a top plate, a middle plate and a bottom plate with an axle holding the plates together and allowing the middle plate to rotate about the axle relative to the top and bottom plates. A number of semi-cylindrical inclined surfaces are formed on each of the plates and one of the surfaces on the middle plate corresponds to the one of the surfaces on each of the bottom and top plates. The corresponding surfaces on the top and bottom plates are oriented to face in the same direction, and the semi-cylindrical surface on the middle plate faces in the opposite direction. When the holder is in a closed position, the semi-cylindrical inclined surfaces of the three plates form a plurality of inclined substantially cylindrical receivers dimensioned to grip and hold the poles. While three plates are preferred, more and fewer plates may be used. The plates are preferably mounted on a ratchet axle, and preferably an over-the-center clamp holds the plates together in the closed position in addition to the action of the ratchet axle.

Another embodiment of the holder includes a hub made up of a core and a plurality of jaws. The jaws are preferably mounted on the core by hinges and semi-cylindrical inclined surfaces are formed in the jaws and in the core to create substantially cylindrical, inclined receivers when the jaws are in a closed position. The receivers tightly grip the poles when the jaws are in the closed position. When the jaws rotate about the hinges to an open position, the inclined semi-cylindrical surfaces move apart and release the poles from the receivers.

The holder may also be mounted on the top ends of the poles to create another type of a tripod structure useful for many different applications. For example, a camera mount may be mounted on the holder at the top of the tripod structure to form a camera tripod. Likewise other accessories may be attached to the holder at the top of the tripod. For camping, the tripod may include accessories such as a tabletop or a lantern secured to the top of a tripod.

It will be appreciated that the holder of the present invention is capable of numerous applications in which elongate members are held to form a useful standing structure, and the above examples should not be construed as limitations upon the standing structures or the holder itself.

### BRIEF DESCRIPTION OF THE DRAWINGS

The present invention may best be understood by reference to drawings of the preferred embodiments in which:

FIG. 1 is a perspective drawing of an assembled standing structure in which a stool is constructed from trekking poles, a detachable hub and a seat;

FIG. 2 is a detailed plan view of a hub used to construct the stool from trekking poles;

FIG. 3 is a cross sectional view of the hub taken through line 3-3 of FIG. 2;

FIG. 4 is a plan of view of the hub showing one section of the hub opened to receive a trekking pole;

FIG. 5 is a side view of the hub shown in FIG. 4;

FIG. 6 is a plan view of an alternate hub;

FIG. 7 is a plan in view of the hub shown in FIG. 6 in an open position;

FIG. 8 is another alternate embodiment of the hub;

FIG. 9 is a cross sectional diagrammatic illustration of a ratchet axle;

FIG. 10 is a perspective view of a corner of a seat designed to receive the handle of a trekking pole;

FIG. 11 is a perspective of view of a corner of a seat designed to receive a section of the trekking pole other than the handle;

FIG. 12 are side views of a trekking pole disassembled into three sections with protective devices shown adjacently to the ends of the sections;

FIG. 13 is a perspective of view of a camera tripod constructed with trekking poles and a detachable hub;

FIG. 14 is a perspective of view of a tripod table constructed using trekking poles and a detachable hub; and

FIG. 15 is a perspective view of a stool with four legs and a detachable hub.

FIG. 16 is a schematic illustration of an alternate construction of the hub.

### DETAILED DESCRIPTION OF PREFERRED EMBODIMENT

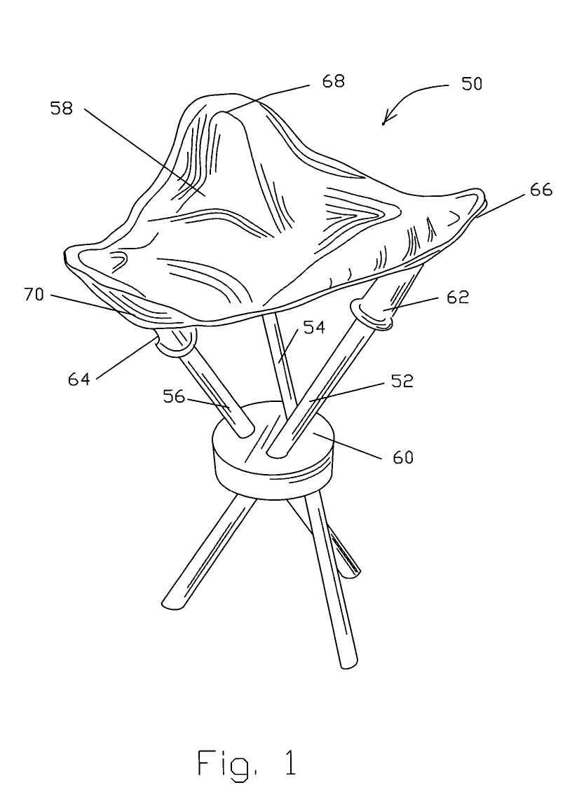

Referring now to the drawings in which like reference characters designate like or corresponding parts throughout the several views, there is shown in FIG. 1 a stool 50 constructed from trekking pole sections 52, 54, and 56, a canvas seat 58 and a hub 60. In this particular embodiment, the pole sections 52 and 56 are the upper sections of two different trekking poles. Each of the sections of 52 and 56 include handles 62 and 64 that are normally used to grip the upper end of a trekking pole.

The hub 60 is detachable. To construct the stool 50, assembled trekking poles are disassembled to obtain three different sections. The trekking pole sections, such as sections 52, 54 and 56 are then inserted into the hub 60. The upper ends of the sections 52, 54 and 56 are inserted into comer pockets 66, 68 and 70 of the seat 58. In this matter, the stool 50 is quickly and conveniently constructed from trekking pole sections using a minimum of light weight material, namely the hub 60 and the seat 58. In a preferred embodiment, the hub 60 is constructed of light weight but strong material such as aluminum, titanium, plastic, semi-rigid rubber, foamed plastic, or foamed metal. The seat is likewise constructed of a lightweight but strong material such as a synthetic fabric or a netting material. Preferably, the seat 58 is constructed of a light weight fire resistant or fire proof material that is water repellent. A netting material is particularly suited for camping environments where it may be exposed to rain and dew. A water repellent netting will allow the rain to pass through, and the moisture that does accumulate on the net seat 58 is easily removed by shaking.

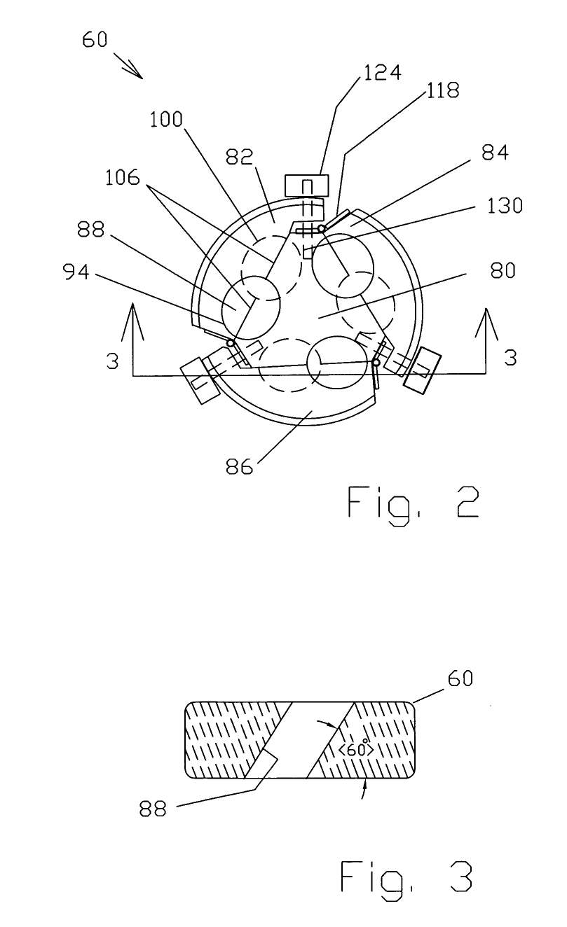

Referring now to FIG. 2, a plan of view of the hub 60 is shown. In this view more details of a hub 60 are provided. The hub 60 includes a triangular center core 80 surrounded by a three clamping jaws 82, 84 and 86 preferably having a semi-cylindrical outer curvature so that the overall shape of the hub 60 is cylindrical. Three bores 88 are formed in the hub 60 with half of each bore being formed in the center core 80 and the other half of each bore 88 being formed in the adjacent jaws 82, 84 and 86. The bores 88 are cylindrical in cross section and intersect the hub of 60 at an angle of about 30 degrees. Thus, the upper end of the bores form elliptical holes 94 in the upper surface of the hub 60. The lower end of the bores 88 forms the elliptical holes 100 in the bottom surface of the hub 60 and are indicated by hidden lines in FIG. 2. The jaws 82, 84 and 86 are separated from the triangular core 80 by surface interfaces 106. The jaws 82, 84 and 86 are secured for rotation on the center core 80 by hinges 118. The hinges 118 may be separate parts or the hinges may be formed as integral parts of the jaws 82, 84 and 86 and the center core 80. For example, pins may be formed on the jaws, and bores may be formed in the center core 80 to receive the pins. The other ends of the jaws 82, 84 and 86 are secured to the center core 80 by thumb wheel bolts 124 that extend through bores in the ends of the jaw and are threaded into threaded receivers 130 in the center core 80.

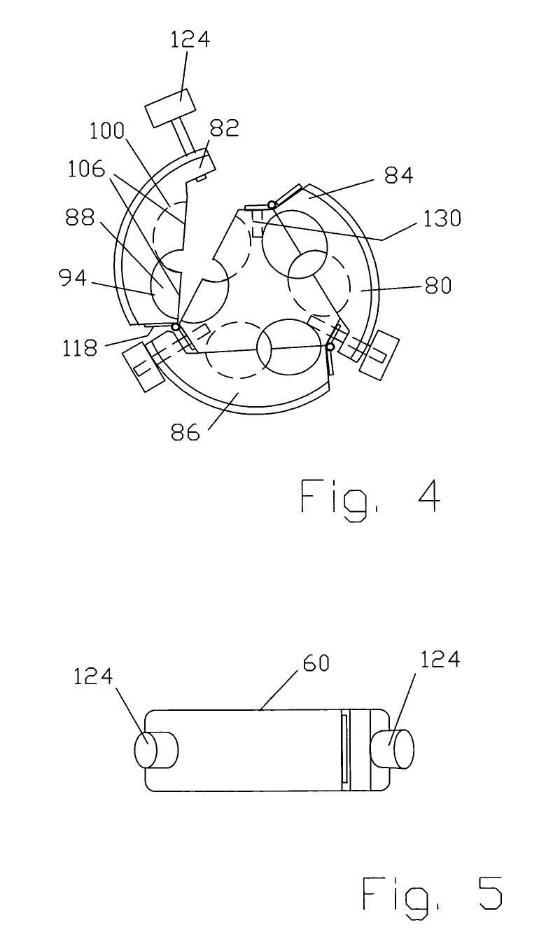

Referring to FIG. 4, the operation of core 60 may be understood. To assemble the stool 50 shown in FIG. 1, each of the jaws 82, 84 and 86 are moved from the closed position shown in FIG. 2 to an open position as illustrated by jaw 82 in FIG. 4. First, the thumb wheel bolts 124 are rotated in a counterclockwise direction which causes the bolts to thread out of the threaded receivers 130, 132 and 134. The bolts 124, rotate freely in the jaws 82, 84 and 86 but they are preferably captured so that they will not be completely removed from the jaws. After each of the jaws 82, 84 and 86 are opened, the pole sections 52, 54 and 56 may be inserted into the bores 88, 90 and 92 which are now separated into a pair of opposing semi-cylindrical surfaces. When the pole sections 52, 54 and 56 are positioned within the bores as shown in FIG. 1, the jaws 82, 84 and 86 are again moved to the closed position and the thumb wheel bolts are used to clamp the jaws to the core 80 and thereby clamp the pole sections 52, 54 and 56 within the bores 88, 90 and 92. The thumb wheel bolts 124 are captured in slots in the jaws 82, 84 and 86 so that the bolts can rotate and slide slightly as necessary to clamp the jaws in different positions depending upon the exact dimensions of the pole sections that are captured in the bores 88.

The surface interfaces 106 illustrate a gap between the jaws 82, 84 and 86 and the central core 80. The gap is needed to allow the jaws to clamp pole sections of different dimensions within the bores 88. Additionally, one of the bores 88 is slightly smaller in diameter compared to the other two bores 88 to receive the smaller of the pole selections, namely, section 54. In addition, the interior surfaces of the bores 88 are constructed from a resilient material such as rubber that will yield when the jaws are clamped against the poles 52, 54 and 56. Thus, the resilient surfaces of the bores 88 provide gripping surfaces to engage the poles 52 so that they will not slide within the bores 88 during use. In addition, the resilient material of the bores 88 will yield under extreme stresses and thereby provide a measure of protection for the poles 52. Instead of denting the poles, the bores 88 will yield slightly to absorb and distribute shocks and stresses imposed on the assembled stool 50.

Referring now to FIG. 3, a cross sectional of view of the hub 60 taken through line 3-3 in FIG. 2 is shown. In this view, it is clear that the bore 98 is angled at approximately 30 degrees with respect to vertical and 60 degrees with respect to horizontal. The exact inclination of the bores 88 is determined by the particular application for which the hub 60 will be used.

Referring to FIG. 5, a side view of the hub 60 shown in FIG. 4 and FIG. 2 is shown. In this view, it may be appreciated that the hub 60 has thumb wheels 124 projecting a sufficient distance from the surface of the hub 60 to allow easy access for releasing the jaws 82, 84 and 86 and securing the jaws to the core 80.

Referring now to FIG. 6, a hub 60a is shown representing an alternate embodiment of the hub 60. Hub 60a is constructed of a top jaw plate 202, a middle jaw plate 204 and a bottom jaw plate 206. Each of the jaw plates 202, 206 and 208 are mounted on a center axle 200. Each of the jaw plates could rotate freely on the axle 200 and be retained by flanges or washers, but it is preferred to fixedly secure the top jaw plate 202 and the bottom jaw plate 206 to opposed ends of the axle 200, and the middle jaw plate 206 is allowed to rotate freely between the top jaw plate 202 and the bottom jaw plate 206. The spacing between the plates 202 and 206 is sufficiently large to allow the plate 204 rotate freely, but is a sufficiently small to snugly hold the middle jaw plate in position between the plates 202 and 206.

As shown in FIG. 6, the top plate 202 covers and partially obscures the middle plate 204. Likewise, the plates 202 and 204 almost completely hide the bottom plate 206. To clarify the construction, the bottom plate 206 is drawn using hidden lines 208. The top plate 202 has three semi-cylindrical surfaces 210 formed in the plate having a diameter that is slightly larger than the diameter of poles that are expected to be received in the semi-cylindrical surfaces 210. Likewise, plate 204 has three semi-cylindrical surfaces 212 formed in it disposed in an opposing relationship to the semi-cylindrical surfaces 210. The opposing semi-cylindrical surfaces 210 and 212 form a receiver that emulates the function of the bores 88 in the hub 60 shown in FIG. 2. Each of the surfaces 210 and 212 is oriented at an angle of about 30 degrees with respect to horizontal, where the top surface of the top plate 202 is a horizontal plane. The semi-cylindrical surface 210 angles underneath the plate 202 so that it is visible only at one edge. The semi-cylindrical surfaces 212 are angled inwardly from top to bottom and thus are visible in FIG. 6. Jaw plates 202 and 204 are almost mirror images. However, since the cylinder defined by the surfaces 210 and 212 has a linear axis, the semi-cylindrical surface 212 is slightly closer to the axle 200 than the surface 210.

The bottom plate 206 also includes a semi-cylindrical surface 214 that is substantially identical to the surface 210. The semi-cylindrical surface 214 is angled in the same direction as the surface 210. Each of the surfaces 212 is aligned with one surface 210 and one surface 214. Thus, the three surfaces 210, 212 and 214 collectively form three inclined cylinders corresponding to the three inclined bores 88 of FIG. 6.

The top and bottom plates 202 and 206 are secured to the middle plate 204 by three spring clamps 216, which are pivotally secured to three pivot points 220 on three levers 218. One end of the lever 218 is secured to pivot point 222 on a base 224. The base 224 is fixedly secured, such as by welds, glue or fasteners, to both the top plate 202 and the bottom plate 206. Teeth 226 are formed on the outer surface of the middle plate 204 and a tooth 228 is formed on the spring clamp 216 to engage the teeth 226. As shown in FIG. 6, the tooth 228 has engaged the teeth and the lever 218 has been pushed downwardly over the center toward the center of the hub 60a and thereby holds the middle plate 204 in a position that would clamp poles when inserted between the semi-cylindrical surfaces 210, 212 and 214. The curvature in the spring and clamp 216 allows the clamp 216 to bend and resiliently yield when it is moving from the open to the closed position. Thus, the clamp 216 imposes a resilient but yielding force on the middle jaw plate 212 in a direction toward the top and bottom jaw plates 210 and 214.

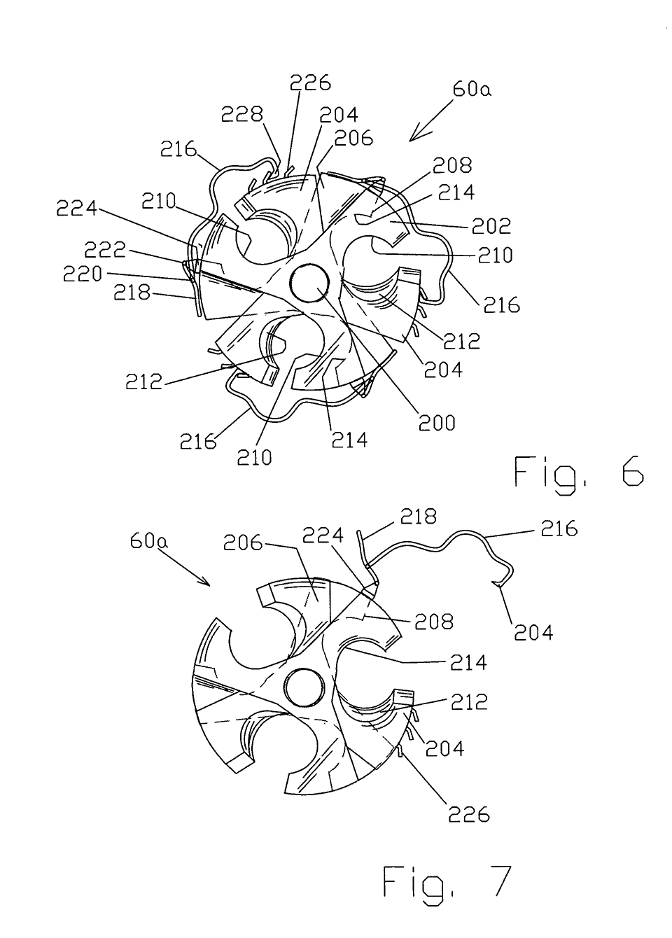

Referring now to FIG. 7, the hub 60a is shown in an open position. To assemble a tripod with the hub 60a, such as the stool 50 shown in FIG. 1, the middle jaw plate 204 is first rotated on the axle 200 to the open position shown in FIG. 7. Then, the poles, such as poles 52, 54 and 56 are inserted into the opening formed between the semi-cylindrical surfaces 210, 212 and 214. Once the poles are in place, the middle jaunt plate is rotated toward the poles and toward the top and bottom jaw plate 202 and 206. Once the poles are loosely held in place, the spring clamp 216 is moved forward to engage the teeth 226 with the lever 218 rotated open toward and over-the-center of the base 224. The lever 218 is then moved from the open position to the closed position as shown in FIG. 6. As the lever 218 moves toward the closed position, it places a force on the spring clamp 216 and “stretches” the spring clamp to place a resilient closing force on the middle jaw 204. A number of teeth 226 are formed on the middle jaw plate 204 so that an appropriate amount of compression can be placed on the poles gripped between the surfaces 210, 212 and 214 even though the poles may have slightly different dimensions and even though the spring clamp 216 may be deform and “stretch” over time.

FIG. 7 has been shown with one spring clamp 216 and associated hardware, while FIG. 6 has been shown with free spring clamps 216. Given the construction of the this particular embodiment, a single spring clamp 216 is sufficient to perform the basic function required to clamp poles in the hub 60a. However, multiple spring clamps 216 provide a level of redundancy and provide increased closing force on the poles. Thus, while one the spring clamp would suffice, it is preferred to provide multiple spring clamps. Also, the top plate 210 is secured to the bottom plate 212 by the base of 224, which extends between the two plates, and it is not necessary that the top and bottom plates be secured fixedly to the axle 214. However, it is preferred to provide increased strength and a level of redundancy by fixedly securing the plates 202 and 206 together by welding the plates to the axle 200 and by securing the plates together with the bases 224 welded to the plates 202 and 206.

The surfaces 210, 212 and 214 are again formed from a resilient material such as rubber. If the plates 202, 204 and 206 are formed from a relatively hard material such as metal, the surfaces 210, 212 and 214 are formed using a resilient material such as a rubber gasket material, preferably at least having a thickness of one sixteenth of an inch. Again, the purpose of the resilient surfaces is to help absorb stress and shock that would otherwise be imposed by the hub 60a on the poles mounted in the hub. In the embodiment shown in FIGS. 6 and 7, the spring clamp 216 also provides a level of resiliency that will protect the poles. If a sudden shock or force is applied to the poles, the resilient springs 216 will yield slightly and absorb the stress or force over a distance thereby helping to prevent damage to the poles.

Referring now to FIG. 8, a hub 60 b is shown representing another alternate hub. The structure of hub 60b is similar to the structure of hub 60a. The hub 60b is formed by a top plate 300, and middle plate 302 and a bottom plate 304, each of which has three inclined semi-cylindrical surfaces 306, 308 and 310 formed in them. The three semi-cylindrical surfaces 308 are positioned in opposing relationship to the semi-cylindrical surfaces 306 and 310. Each of the surfaces 306, 308 and 310 are inclined at an angle of about 30 degrees with respect to horizontal, where the top surface of the top plate 300 is considered horizontal. As shown in FIG. 8, the inclined surface 308 is visible because it inclines inwardly from top to bottom, whereas the inclined surfaces 306 and 310 are visible only at an edge because they incline outwardly from top to bottom as shown in FIG. 8. Because of the opposed relationship, the inclined semi-cylindrical surfaces 306, 308 and 310 define a cylinder corresponding to the bore 88 (FIG. 3) shown in the hub 60.

The plates 300, 302 and 304 are mounted on a ratchet axle 312. The top plate 300 and the bottom plate 304 are fixedly secured to the outer ends of the ratchet axle 312 with the middle plate 302 mounted for rotation on the axle 312 relative to the top and bottom plates 300 and 304. In this embodiment, a button 314 is formed in the center of the axle 312. By pressing the button 314, an internal ratchet mechanism in the ratchet axle 312 is released. The middle plate 302 is allowed to rotate about the ratchet axle 312 toward the other two plates 300 and 304 by the ratchet axle, but reverse rotation, rotation away from plates 300 and 304 is prevented by the ratchet mechanism in of the ratchet axle 312 until the button 314 is pressed. Preferably the ratchet axle 312 is constructed of spring material so that it acts as a torsion spring and yields slightly when large forces are applied to the poles. This torsion spring action is again designed to relieve sudden momentary stresses imposed on the poles.

In this embodiment, three braces 316 are fixedly mounted between the top plate 300 and the bottom plate 304. The braces 316 provide increased rigidity and strength, but are also redundant. If desired, the braces 316 could be omitted.

To assemble a tripod using the hub 60b, the button 314 is pressed releasing the ratchet mechanism of ratchet axle 312, and the middle plate 302 is rotated in a clockwise direction away from the top and bottom plates 300 and 304. When the plate 302 has been rotated to a fully open position, the ratchet re-engages and prevents further opening motion. When the jaw plate 302 is in the fully open position, poles are inserted into the area defined between the semi-cylindrical surfaces 306, 308 and 310. The middle jaw plate 302 is then forced toward the closed position clamping the poles between the surfaces 308 and the opposed surfaces 306 and 310. In this embodiment, the surfaces 306, 308 and 310 are preferably resilient, and are preferably more resilient than the surfaces described previously. In this embodiment, when the jaw plates are forced to gather to clamp the poles between the surfaces 306, 308 and 310, it is the resilience of the surfaces alone that provide a resilient clamping force against the poles. The jaw plates 300-304 are forced together compressing the surfaces of 306-310, and the ratchet axle 312 will prevent reverse rotation thereby holding the surfaces 306-310 in a resilient clamping position. If greater force is needed for a particular application, a spring clamp, such as spring clamp 216 of FIG. 6 may be used in the hub 60b shown in FIG. 8. Referring again to FIGS. 6 and 7, it will be appreciated that the hubs 60a could also use a ratchet axle similar to ratchet axle 312, and it will be understood that the axle 200 also symbolically represents a ratchet axle.

The jaw plates 302, 304 and 306 are preferably made of resilient material. that will flex and allow a variety of different sizes of poles be clamped between the surfaces 306, 308 and 310, even if the poles do not have the exact correct dimensions. Most preferably the plate material is a titanium or aluminum alloy, but it may also be a polymer such as nylon, vinyl or other plastic material.

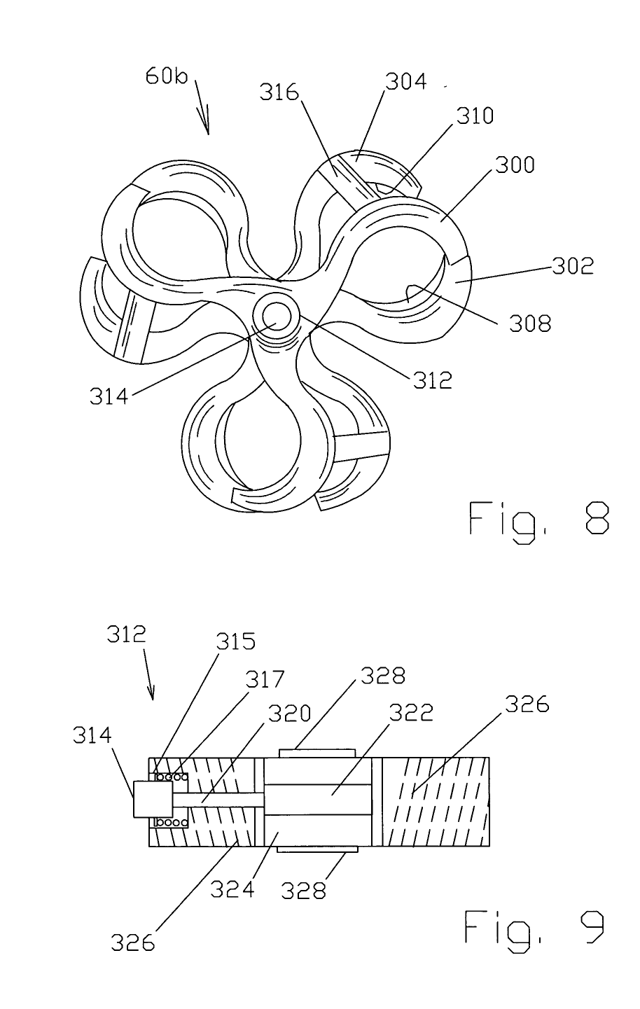

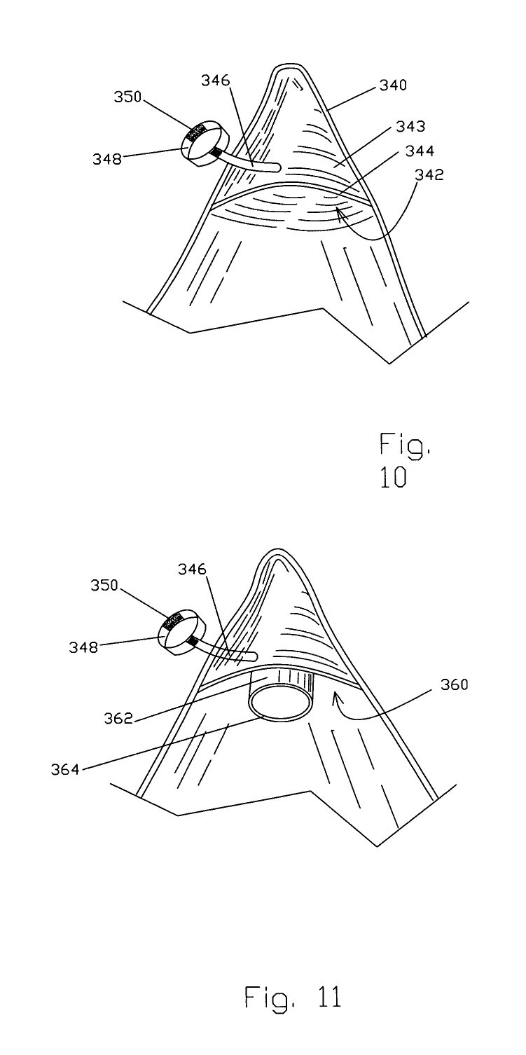

The ratchet axle 312 is schematically shown in cross section in FIG. 9. The button 314 may be depressed into a recess 315 in which a spring 316 is located to yield and allow the button 314 to enter the recess 315. When the button 314 is released, the spring 316 urges it outwardly to return to the rest position. The button 314 is attached to a pushrod 320 that actuates and de-actuates a ratchet mechanism 322. A sleeve 324 is mounted on the outside of the ratchet mechanism 322 which allows the sleeve 324 to rotate in one direction but prevents it from rotating in the other direction when the button 314 is not depressed. When the button 314 is depressed, the sleeve 324 may rotate in either direction around the ratchet mechanism 322. In this embodiment, threads 326 are shown on both ends of the ratchet axle 312. Preferably, the interior portions of the threads 326 are burred. When the plates 300 and 304 are threaded onto the axle 312, the burred threads lock the plates into a final position. Also, in this embodiment, keys 328 are disposed on the exterior of sleeve 324. The middle plate 302 has key ways designed to receive the keys 328 and thereby lock the middle plate 302 onto the sleeve 324. While threads and keys are shown in this preferred embodiment, other suitable means for mounting the plates 300-304 onto the axle 312 may be used such as welding, gluing, friction fitting, etc.

Referring now to FIG. 16, there is shown an alternate embodiment in which a hub 480 represents any of the hubs previously described. A ring 482 is positioned and secured to the hub 480 by loops 481 that loosely secure the ring to the hub. The ring 482 may be constructed of a flexible strong material, such as wire, woven wire, a metal band, or a woven polyester strap. A mount 484 is secured on one end of the ring 482, and a lever 486 is pivoted at pivot point 488 on the mount 484. A latch spring 480 is connected at one end to the mid-region of the lever 486 and is configured at its other to engage catches 492. In the schematic representation of FIG. 16, the spring latch 490 and the lever 486 are shown in a closed position squeezing the hub 480 and holding it in a closed position. When the lever 486 is lifted and latch spring 490 disengages the catches 492, the ring 482 slides in the loops 481 and allows the hub 480 to move to an open position.

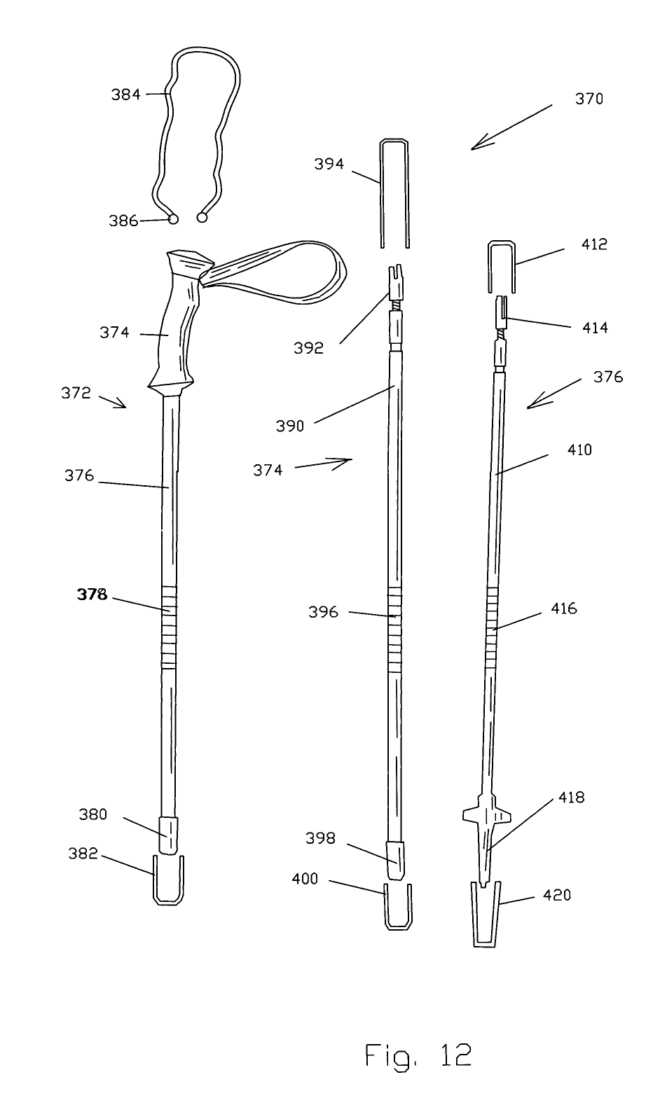

Referring now to FIGS. 1 and 10 details of the preferred seat 58 are described. As best shown in FIG. 10 a reenforcing bead 340 is formed around the perimeter of the seat 358 to provide strength and resistance to wear. A pocket 342 is formed in some or all of the comers of the seat 358 by the somewhat triangular fabric section 343. An elastic bead 344 extends along the outer edge of the fabric section 343 and draws the pocket 342 closed. In FIG. 10, the pocket 342 is shown in an open position with the elastic bead 344 stretched to almost its maximum length. The pocket 342 is dimensioned to snugly receive the handles 62 and 64 as shown in FIG. 1. The elastic bead 344 causes the pocket 342 to snugly collapse upon and grasp the handles 62 and 64. For additional security, a strap 346 is attached at one end to the edge of the pocket 342 and is attached at the other end to a loop 348 that includes a Velcro closure 350. The strap 346 and loop 348 are dimensioned so that the loop 348 may be positioned on the pole sections, such as 52 and 56, and secured to the pole sections by the Velcro closure 350. Preferably the interior surface of loop 348 is rubberized or otherwise treated with a material that will prevent slippage on the poles 52 and 56. In this manner a handle 62 may be secured in the pocket of the seat 58 for use as a stool.

FIG. 11 shows a variation of the pocket 342 of FIG. 10. In FIG. 11, a pocket 360 is formed in the seat 58 in a manner similar to that described above. However, in this embodiment, a cylindrical sleeve 362 is permanently or temporarily secured in the pocket 360. Permanent attachment may be achieved by sewing, permanent straps, gluing, or other suitable fasteners. Temporary attachment uses snaps, Velcro fasteners, straps or other suitable temporary fasteners. The sleeve 362 is closed at its interior end and curved to reduce abrasion to the pocket 360. The curved interior end is not shown in FIG. 11 because it is within the pocket 360. The exterior end 364 of the sleeve 362 is dimensioned to snugly receive an end of the pole sections, such as 52, 54 or 56, that do not include handles. Some of these ends will include a locking mechanism such as an expandable nut or a clutch mechanism. The sleeve of 362 is designed to receive the locking mechanism and is dimensioned to allow the locking mechanism to lock within the sleeve 362, thereby securing a pole section in the pocket 360.

Referring now to FIG. 12, a representative trekking pole 370 is shown. In this view, the pole 370 is broken down into three sections, namely, the handle section 372, the middle section 374, and the tip section 376. In use as a walking stick these sections are telescoped together to form a single walking stick. The handle section 372 includes a handle 374 mounted on one end of a pole 376. Markings 378 are placed on a middle portion of the pole 376 and to indicate a reinforced portion of the pole 376. This reinforced portion is positioned within the hub 360 when it is used to create the stool 50 shown in FIG. 1. The reinforcement indicated by markings 378 is preferably provided by a cylinder of high strength material that is wedged or otherwise secured within the pole 376. The reinforcing could also be provided on the outside of the pole or it could be manufactured into the pole as a thickened wall. The lower end of the pole section 372 is tipped by a reinforcing sleeve 380. This sleeve is permanently attached to the pole and remains in place when the pole 370 is assembled as a trekking pole. An additional sleeve 382 is provided as an accessory to fit snugly over the sleeve of 380 and protect it when the pole section 372 is being used as a portion of the stool 50.

When the stool 50 is assembled as shown in FIG. 1, the sleeve 382 is mounted over the sleeve 380 to protect it from the ground. However, the stool 50 may also be constructed by placing the other end of pole section 372 into a pocket in the seat 58. In such case, the sleeve 382 would be permanently or temporarily secured within the pocket 360 as previously discussed with regard to sleeve 364.

A fabric sleeve 384 with an elastic mouth 386 is provided to protect the handle 374 when it is used in the stool 50. The elastic mouth 386 expands to receive the handle 374 and then collapses around the section 376 to hold the sleeve 384 in place on the handle. Both sleeves 382 and 384 are shown in cross section in FIG. 12 to maximize clarity of illustration.

The middle section 374 is outfitted with accessories similar to section 372. The middle section 374 includes a pole 390 with a locking mechanism 392 mounted on its upper end. In this preferred embodiment, the locking mechanism is an expandable nut, but other suitable locking mechanisms may be used. A protective sleeve 394 is provided for the upper end of pole 390. It is dimensioned to receive the locking mechanism 392 and allow the locking mechanism to secure itself within the sleeve 394.

Markings 396 are provided near the center of the pole 390 to indicate a reinforced section that is constructed in the same manner as previously described in association with markings 378. A sleeve 398 is permanently mounted on a lower end of poles 319 and a protective sleeve 400 is provided to fit over sleeve 398. Sleeves 398 and 400 are similar to and correspond to sleeves 382 and 380, previously described. As before, sleeves 394 and 400 are shown in cross section for clarity of the illustration. With the sleeves 394 and 400 mounted on the poles 390, it may be used to construct the stool 50 in the manner previously described with respect to pole section 372.

The tip section 376 is constructed like the previously described sections. Section 376 includes a pole 410 and accessories are provided including a sleeve 412 dimensioned to receive and lock onto a locking mechanism 414. Markings 416 are provided at the center of pole 410 to designate a reinforced portion and a trekking tip 418 is mounted on the lower end of the pole 410. A protective sleeve 420 is provided to snugly fit over the trekking tip 418. When the sleeves of 412 and 420 (shown in cross section) are mounted on the pole 410, the tip section 376 may be used to construct the stool 50 in the manner described with respect to the other sections.

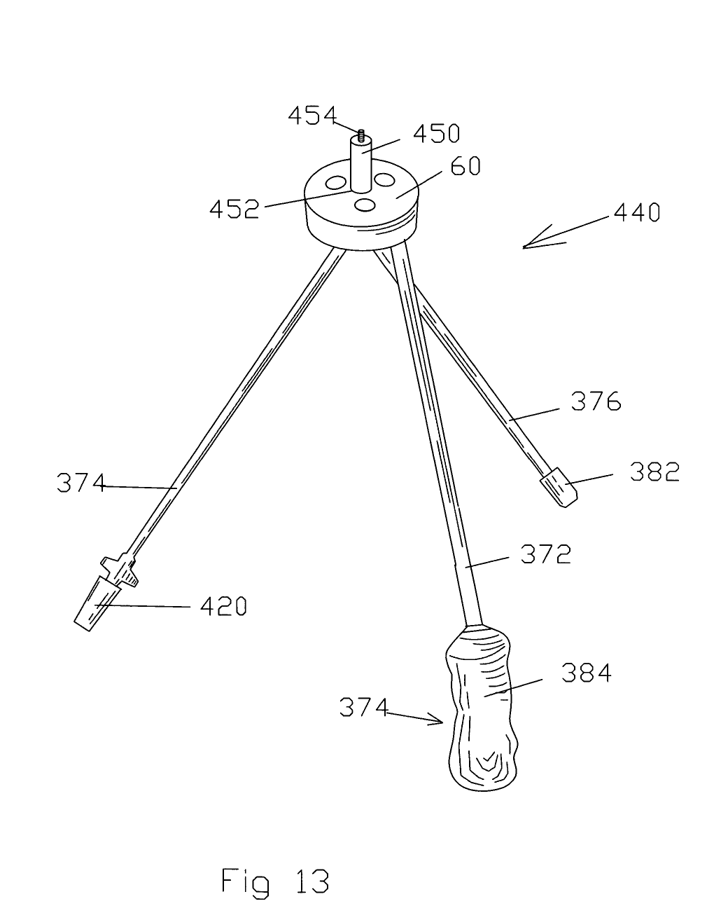

Referring now to FIG. 13, an alternate embodiment of the invention is shown. In this embodiment a tripod 440 is constructed in a manner similar to the tripod portion of the stool 50. In the tripod 440, the hub 60 is mounted to the top end of each of the pole sections 372, 376 and 374. An accessory 450 is mounted on the tool hub 60 and may represent any desired accessory that requires or may use a tripod base. In this particular example, the accessory is a camera mount. The lower end 452 is secured to the hub 60 by threads, a bayonet lock, or other suitable fastener. A camera fastener 454 extends up from the accessory 450 and is preferably a standard threaded camera mount dimensioned for insertion into a standard camera receiver.

The tripod 440 shown in FIG. 13 uses a different combination of pole sections as compared to the tripod used in the seat 50. In FIG. 13 all three sections of the trekking pole 370 are used. Also, the positions of the poles are different. The handle section 372 is shown with the handle 374 engaging the ground with a protective sleeve 384 covering the handle 374. This variation is intended to help illustrate the various combinations of pole sections and construction positions that can be assumed by the tripod 440 using the hub 60.

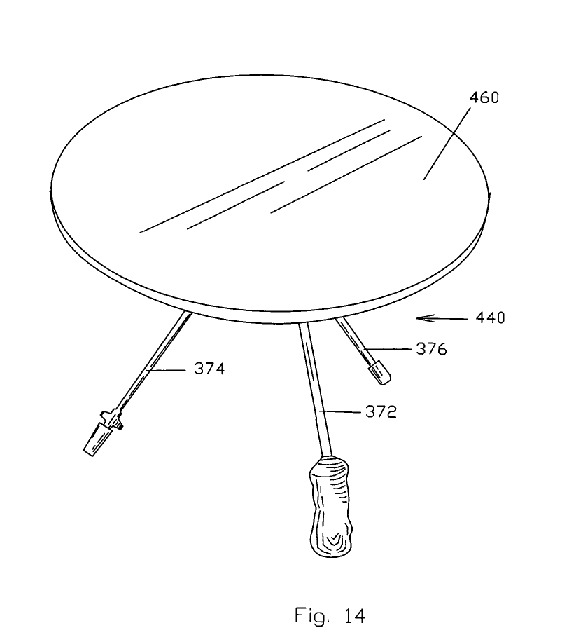

In FIG. 14 a different accessory 460 is shown mounted on the tripod 440. In this embodiment, the accessory 460 is a small table top preferably constructed of a light weight material mounted to the hub 60 by suitable fasteners such as threaded screws, bayonet locking mechanisms, etc. This embodiment is intended to help illustrate the variety of accessories that may be used with the tripod 440.

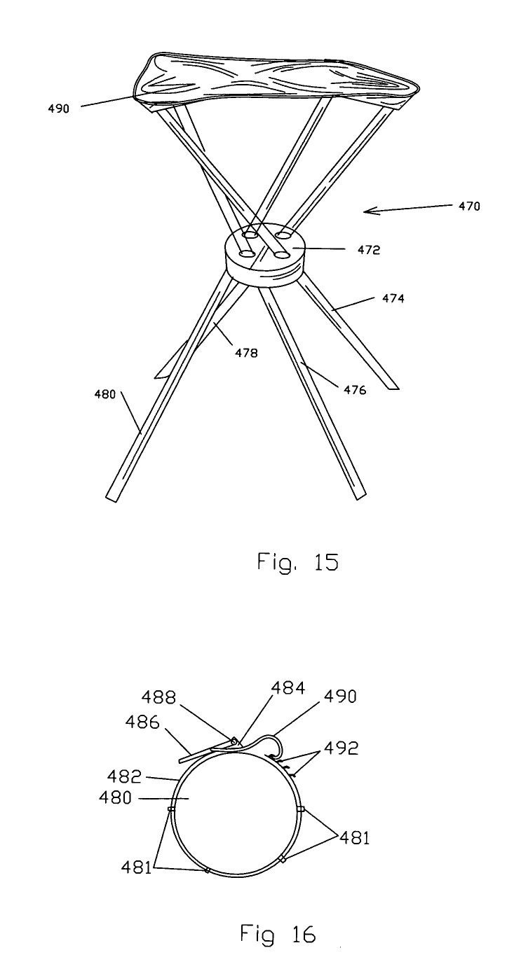

Referring now to FIG. 15, there is shown a somewhat diagrammatic illustration of another embodiment of the present invention in which a stool 470 is shown. The stool 470 includes a hub 472 and four legs 474, 476, 478 and 480. The four legs 472-480 are held in a rectangular inclined orientation to support a rectangular seat 490. This embodiment illustrates the variation in the number of legs that may be used in the invention. While the drawing of FIG. 15 illustrates the legs 474-480 as generic poles, it will be understood that the legs 474-480 may also be constructed from sections of a trekking pole or wading staff as previously described.

Having described multiple embodiments of the invention, it will be appreciated that the invention is capable of numerous rearrangements and substitutions of parts without departing from the spirit of the invention. The embodiments are intended as illustrations or examples of the invention and are not intended as limitations to the scope of the invention as described in the appended claims.

1. A pole and structure apparatus comprising:
A plurality of poles, each pole having a midsection and upper and lower ends;
A holder having an open position and a closed position, said holder being dimensioned and configured for gripping each of the plurality of poles when the holder is in a closed position, the holder being further configured to hold and orient the poles to form a structure having a plurality of legs, the legs being configured and positioned for engaging the ground and creating a standing structure, the holder being configured to release the poles when moved to the open position to enable disassembly of the structure;
A closure mechanism associated with a holder for securing the holder in a closed position to secure the poles in a desired position;
a release mechanism associated with the holder and the closure mechanism for releasing the closure mechanism and for releasing the poles from the holder to enable disassembly of the structure:

2. The apparatus of claim 1 wherein said holder further comprises:
a hub including a plurality of movable hub components operable to move between a closed position and an open position;
Said hub components being configured to form cylindrical receivers when the hub components are in the closed position, the cylindrical receivers being dimensioned to receive and tightly grip the poles when the closure mechanism holds the poles in a closed position; and Said hub components being configured and dimensioned to release the poles when the hub components are moved to the open position.

3. The apparatus of claim 1 wherein said holder engages the midsections of the poles to form a tripod structure having three downwardly extending legs and having three upwardly extending legs.

4. The apparatus of claim 1 wherein said holder engages the midsections of the poles to form a tripod structure having three downwardly extending legs and having three upwardly extending legs and further comprising a triangular seat having the three comers and pockets formed in the comers to receive the upper ends of the poles and mount the seat on the poles, the seat being dimensioned to extend tightly between the upper ends of the three upwardly extending legs to form a tripod stool with a seat supported by the poles.

5. The apparatus of claim 1 where in the closure mechanism is an over-the-center clamp for applying a force to the holder urging the holder toward a closed position and thereby holding the holder in a closed position.

6. The apparatus of claim 1 wherein said holder comprises:
a top plate, a middle plate and a bottom plate;
An axle for holding each of the plates and for allowing at least the middle plate to rotate about the axle relative to the top and bottom plates;
A plurality of semi-cylindrical inclined surfaces being formed on each of the top plate, middle plate and bottom plate, each of the semi-cylindrical inclined surfaces on the top plate corresponding to one of the semi-cylindrical surfaces on the bottom plate, the corresponding semi-cylindrical surfaces on the top and bottom plates being oriented to face in the same direction;
Each of the semi-cylindrical inclined surfaces on the middle plate corresponding to one of the semi-cylindrical inclined surfaces on the top or bottom plate and being oriented to face in an opposite direction, opposite from the same direction, each of the semi-cylindrical inclined surfaces of the bottom and top plates being positioned in an opposing relationship to one of the semi-cylindrical inclined surfaces of the middle plate so that when the holder is in a closed position, the semi-cylindrical inclined surfaces form a plurality of inclined cylindrical receivers dimensioned to grip and hold the poles.

7. The apparatus of claim 1 wherein said holder comprises:
a plurality of plates;
An axle for holding each of the plates and for allowing at least the one plate to rotate about the axle relative to another plate;
A plurality of semi-cylindrical inclined surfaces being formed on each of the plates, each of the semi-cylindrical inclined surfaces on the one plate corresponding to one of the semi-cylindrical surfaces on the other plate; and
Each of the semi-cylindrical inclined surfaces on the one plate being oriented to face in an opposite direction from the corresponding ones of the semi-cylindrical inclined surfaces of the other plates so that when the holder is in a closed position, the semi-cylindrical inclined surfaces form a plurality of inclined cylindrical receivers dimensioned to grip and hold the poles.

8. The apparatus of claim 1 wherein said holder comprises:
A plurality of plates dimensioned and configured for forming cylindrical inclined receivers for the poles;
A ratchet axle having a ratchet mode of operation and a freewheeling mode of operation for mounting the plates in an adjacent relationship and, in the ratchet mode of operation, allowing the plates to move in one direction relative to each other and preventing the plates from moving in the opposite direction relative to each other; and
A release mechanism associated with the ratchet axle for being actuated to release the ratchet axle and place the ratchet axle in the freewheeling mode of operation that allows the plates to move in at least said opposite direction.

9. The apparatus of claim 1 wherein said holder comprises:
A hub for holding the poles, the hub comprising:
A core;
A plurality of the jaws and mounted on the core, said jaws and core being dimensioned and configured to form inclined cylindrical receivers for gripping and holding the poles.

10. The apparatus of claim 1 wherein said holder comprises:
A core having a plurality of semi-cylindrical inclined surfaces formed in the core;
A plurality of the jaws, each jaw having a semi-cylindrical inclined surfaces formed in the jaw;
A plurality of hinges, each hinge mounting one jaw on the core with the semi-cylindrical inclined surfaces of the core being a position opposite from the semi-cylindrical inclined surfaces of the jaws, each of said jaws being moveable on one of said hinges to a closed position to form a cylindrical receiver dimensioned and configured for gripping and holding the poles, each of said jaws being movable on one of said hinges to an open position to release the poles from the cylindrical receiver.

11. The apparatus of claim 1 wherein said holder comprises:
A core having a plurality of semi-cylindrical inclined surfaces formed in the core;
A plurality of the jaws, each jaw having a semi-cylindrical inclined surfaces formed in the jaw;
A closure mechanism for holding in the jaws in a closed position in which the poles are gripped between the semi-cylindrical inclined surfaces of the core and the jaws; and
A release mechanism for releasing the closure mechanism and allowing the jaws to move to an open position in which poles may be removed from the grip of the semi-cylindrical inclined surfaces.

12. The apparatus of claim 1 wherein said poles further comprise reinforcement along the midsection of each pole for engaging the holder and resisting forces applied by the holder to the pole so that the holder does not deform the pole.

13. The apparatus of claim 1 further comprising a plurality of sleeves dimensioned and configured to fit on the ends of each pole and protect the pole end during use in the standing structure.

14. The apparatus of claim 1 further comprising an accessory attached to the holder when the holder and poles are formed into the standing structure.

15. The apparatus of claim 1 further comprising a camera mount attached to the holder, said holder being attached to the upper ends of each leg to form a standing structure in the form of a tripod with the camera mount disposed at the top of the tripod.

16. The apparatus of claim 1 further comprising a tabletop attached to the holder, said holder being attached to the upper ends of each leg to form a standing structure in the form of a tripod with the table top disposed at the top of the tripod.

17. The apparatus of claim 1 wherein said holder engages the midsections of the poles to form a standing structure having a plurality of downwardly extending legs and having a plurality of upwardly extending legs and further comprising a seat having a plurality of comers and pockets formed in the comers to receive the upper ends of the poles and mount the seat on the poles, the seat being dimensioned to extend tightly between the upper ends of the upwardly extending legs to form a stool with a seat supported by the poles.

18. An apparatus for holding elongate members to form a structure comprising:
A first holding member having a midregion and a plurality of engagement members extending from the midregion, each of the engagement members including a first engagement surface oriented in a first direction;
A second holding member having a mid region and a plurality of engagement members extending from the midregion, each of the engagement members including a second engagement surface oriented in a second direction;
A connector for connecting the first and second holding members together in a position orienting the first and second of holding members to place at least some of the first engagement surfaces in an opposing relationship with at least some of the second engagement surfaces;
A closure mechanism for retaining the first and second holding members in a closed position in which the elongate members may be gripped between the first and second engagement surfaces, and for being released and allowing the first and second engagement surfaces to move apart enabling release of the elongate members from the grip of the first and second engagement the surfaces.

19. The apparatus of claim 18 wherein the engagement members extend generally outwardly and radially from the midregion of each of the first and second holding members and wherein the first and second engagement surfaces are each inclined semi-cylindrical surfaces dimensioned to engage and substantially conform to the elongate members.

20. The apparatus of claim 18 wherein the connector is an axle for mounting the first and second holding members in a side-by-side parallel relationship, said first and second holding members being mounted on the axle with at least one of said holding members being mounted on the axle for rotation relative to the other holding member.

21. The apparatus of claim 18 further comprising:
A third holding member having a midregion and a plurality of engagement members extending from the midregion, each of the engagement members including a third engagement surface oriented in the first direction;
The connector retaining the first second and third holding members in a side by side parallel relationship with the second holding member being positioned between the first and third holding members, the second holding member being retained by the connector for rotation relative to the first and third holding members;
The closure mechanism for retaining the first, second and third holding members in a closed position in which the first, second and third engagement surfaces form receivers dimensioned and configured to grip and hold the elongate members with the first and third engagement surfaces being disposed on one side of the elongate members and the third engagement surfaces being disposed on the opposite side of the elongate members in an opposing relationship to the first and third engagement surfaces so that the plurality of elongate members may be gripped between the plurality of first and third engagement surfaces on one side and the plurality of third engagement surfaces on the other side of the elongate members.
